(19) United States
(12) Patent Application Publication
(10) Pub. No.: US 2013/0251271 A1
(43) Pub. Date: Sep. 26, 2013

(54) Method for Low Bit-Depth Image Generation

(71) Applicant: Yan Xin Li, Burlington (CA)

(72) Inventor: Yan Xin Li, Burlington (CA)

(73) Assignee: Yan Xin Li, Burlington (CA)

(21) Appl. No.: 13/427,894

(22) Filed: Mar. 23, 2012

(51) Int. Cl. G06K 9/68

(52) U.S. Cl. 382/218

(57) ABSTRACT

The present invention provides method to reduce the computation cost of generating low bit-depth image. One embodiment of the invention first truncates one or more least significant bits of image pixels, then filters the LSB-truncated-pixel image, and finally the truncated-pixel image and filtered image are compared to construct a low bit-depth image. To compute the filtered pixel value, one embodiment of the invention computes some intermediate values, saves and uses the said intermediate values for computing the next pixel. One embodiment of the present invention provides method of generation the filtered image by assigning a plurality of filtered image pixels with the same value.

### FIELD OF THE INVENTION

The present invention relates in general to image processing and filtering method for low bit-depth image generation.

### BACKGROUND OF THE INVENTION

In image processing, there are occasions that need to transform the original image to a simplified low bit-depth image and then do further processing using the transformed low bit-depth image. There are many ways to do the transform, one important method is to filter the image using a multi band-pass filter and then compare the original image and filtered image to generate the low bit-depth image.

FIG. 1 shows the process. Original image F is first filtered to image F′, then F and F′ are compared to generate the low bit-depth image G.

One-bit transform (1BT) [1] method was one of the earliest proposed approaches to generate low bit-depth image. Equation [001] shows the filter kernel that is used for 1BT. The image F is transformed into one-bit/pixel image by comparing the original image against a multi band-pass filtered image F′. A 17×17 filter kernel in the form of Equation [001] is used to filter the image.

$$K ( i , j ) = \{ \begin{matrix}1 / 25 & if i , j ∈ [ 0 , 4 , 8 , 12 , 16 ] \\ 0 , & otherwise\end{matrix} \qquad [ 001 ]$$

The 1-bit bit-plane of an image is constructed using Equation [002], where I_{F}(i,j) represents the value of pixel at position (i,j) of the filtered image F′ obtained by applying the convolution kernel, and I(i,j) represents the value of pixel at position (i,j) of the input image F.

$$B ( i , j ) = \{ \begin{matrix}1 & if I ( i , j ) \geq {I}_{F} ( i , j ) \\ 0 , & otherwise\end{matrix} \qquad [ 002 ]$$

The 1BT uses floating-point multiplications for the normalization of the kernel. Floating point multiplications are slow, both in software and hardware implementations. To reduce the computation cost, multiplication-free 1BT (MF-1BT) [2] approach was proposed. In this approach, the number of the non-zero elements and the structure of the kernel are changed so as not to lose any accuracy. The number of non-zero elements is reduced from 25 to 16, and the shape of the kernel is changed from rectangular shape to a diamond shape structure. The new kernel for MF-1BT is shown in FIG. 2. Because of the normalization coefficient of the kernel is a power of two, the filtering is carried out by adding the corresponding 16 pixels and shifting the final result. The filtering operation can be carried out using only integer arithmetic. The computational load is 15 additions and 1 shift operation per pixel.

Constrained 1-bit transform (C-1BT) [3] was proposed to improve accuracy of low-bit depth image. First, an 1-bit plane is constructed in the same way as 1BT and MF-1BT, at the same time an additional constraint mask (CM) 1-bit plane is created to discriminate reliable pixels. The CM and 1BT bit planes are employed together to obtain a 2-bit depth image.

Though MF-1BT can simplify the low bit-depth image generation, the computation cost is still high. Method that can further reduce the computation cost is highly desirable.

### SUMMARY OF THE INVENTION

Therefore, an object of the present invention is to provide low bit-depth image generation method with reduced computation cost. The method is accomplished as: first, one or more least significant bits (LSB) of image pixels is truncated. Then, the LSB-truncated-pixel image is filtered using multi band-pass filter. Finally, LSB-truncated-pixel image and filtered image are compared to generate a low bit-depth image.

Another object of the present invention is to provide a method to reduce the operations needed for filtering of image when generating low bit-depth image. To compute the filtered pixel value, some intermediate values are calculated and saved for computing the next pixel. The next filtered pixel is selected in a way that the intermediate values of last pixel can be reused for computing the value of this next pixel.

Another object of the present invention is to provide method of generation of the filtered image by assigning a plurality of filtered image pixels with the same value. Each time after one pixel value of filtered image is computed, one or more other pixels around this pixel are assigned with the same value to reduce the amount of computation needed.

### BRIEF DESCRIPTION OF THE DRAWINGS

FIG. 1 shows process of generating low bit-depth image from original full bit-depth image.

FIG. 2 shows the filter kernel for MF-1BT.

FIG. 3 shows one preferred embodiment using LSB-truncated method

FIG. 4 shows the input 8-bit depth 16×12 image F.

FIG. 5 shows LSB-Truncated 16×12 image after least significant 4-bit is truncated.

FIG. 6 Shows a rectangular shape filter kernel

FIG. 7 Shows filtered image with 1^{st} to 4^{th} pixels computed

FIG. 8 shows a plurality of filtered pixels assigned with the same value.

FIG. 9 and FIG. 10 shows filtered image.

FIG. 11 shows 1-BT image

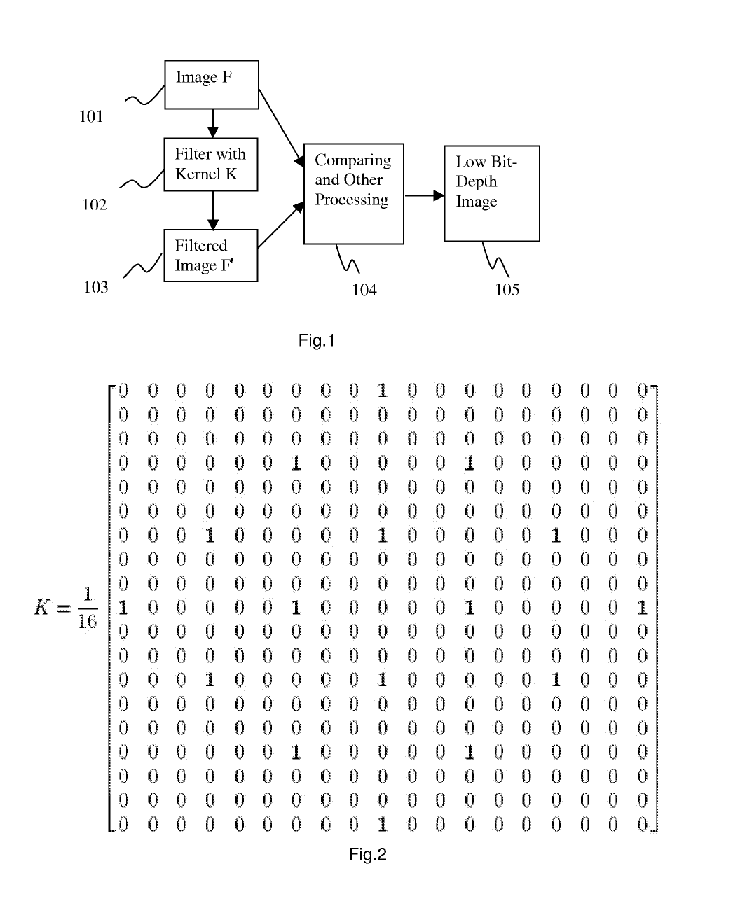

### DESCRIPTION OF THE PREFERRED EMBODIMENTS

### First Preferred Embodiment

In the process of generating a low bit-depth image, the conventional method usually uses full bit-depth pixels of the original and filtered images for processing. This is not always necessary.

The method provided by this invention truncates one or more least significant bits (LSB) of pixels of input image first, and uses only most significant bits (MSB) for further filtering, comparison and other processing. Using the LSB-truncated image instead of the full bit-length image will reduce both memory usage and computation cost.

The accuracy of the filtered image will be degraded when using LSB-truncated image instead of the full bit-length image. The more the bits truncated, the serious the degradation. So the filtered image accuracy and computation cost needs to be traded off to select the appropriate number of truncated bits when using this method.

The present invention provides a method for generating low bit-depth image G from an image F, comprising:
(1) A image processing part for truncating one or more least significant bits (LSB) of pixels of input image F to obtain LSB-truncated image Ft;
(2) A filter part for filtering the LSB-truncated image Ft to filtered image Ft′;
(3) An output part for generating low bit-depth image G by applying comparison and other possible processing operations to Ft and Ft′.

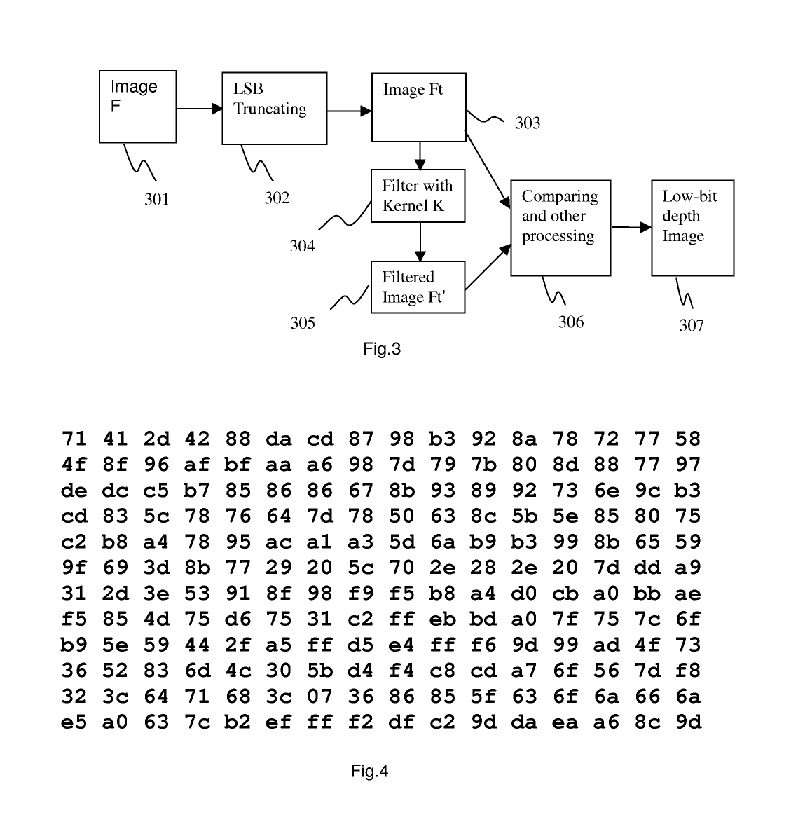

FIG. 3 shows diagram of the preferred embodiment using the method provided by this invention.

### Second Preferred Embodiment

In the process of generating a low bit-depth image, the convention method usually computes the filtered pixel one by one and the total computation depends on how many operations are needed for each pixel.

For example, when using filter kernel for MF-1BT shown in FIG. 2, computation of fifteen additions and one shift operation per pixel is needed.

This invention provides a method to reduce the computation of additions needed per pixel for filtering the image to generate the filtered image F′.

Using a filter kernel K of M×M (M=3, 5, 7, 9, 11, . . . ) size, to compute the value of filtered image pixel p′[m,n], the following Equation [003] can be applied by convolution of original image pixel p[m,n] and filter kernel k[m,n]:

p′[m,n]=p[m,n]*k[m,n]=Σ_{j=-∞}^{∞}Σ_{i=-∞}^{∞}p[i,j]×k[m−i,n−j] [003]

where * means convolution and × means ordinary multiplication, p[m,n]*k[m,n] means the convolution of image and filter kernel.

For example, if the filter kernel for MF-1BT shown in FIG. 2 is used for the filtering, Equation [003] can be written as:

$${p}^{′} [ m , n ] = {\sum }_{j = n - 9}^{n + 9} {\sum }_{i = m - 9}^{m + 9} p [ i , j ] \times k [ m - i , n - j ] = ( ( p [ m , n - 9 ] + p [ m - 3 , n - 6 ] + p [ m - 6 , n - 3 ] + p [ m - 9 , n ] ) + ( p [ m + 3 , n - 6 ] + p [ m , n - 3 ] + p [ m - 3 , n ] + p [ m - 6 , n + 3 ] ) + ( p [ m + 6 , n - 3 ] + p [ m + 3 , n ] + p [ m , n + 3 ] + p [ m - 3 , n + 6 ] ) + ( p [ m + 9 , n ] + p [ m + 6 , n + 3 ] + p [ m + 3 , n + 6 ] + p [ m , n + 9 ] ) ) / 16 \qquad [ 004 ]$$

Equation [004] can be further written as:

p′[m,n]=(P0+P1+P2+P3)/16 [005]

The meanings of P0 to P3 are shown in Equation [006] to [009].

P0=p[m,n−9]+p[m−3,n−6]+p[m−6,n−3]+p[m−9,n] [006]

P1=p[m+3,n−6]+p[m,n−3]+p[m−3,n]+p[m−6,n+3] [007]

P2=p[m+6,n−3]+p[m+3,n]+p[m,n+3]+p[m−3,n+6] [008]

P3=p[m+9,n]+p[m+6,n+3]+p[m+3,n+6]+p[m,n+9] [009]

When using convention method, the filtered pixel p′[m,n] is computed one by one and there is no relation with each other. This invention selects the filtered pixels to be computed so that one filtered pixel can reuse the intermediate results of previous filtered pixel.

For example, if the filter kernel for MF-1BT in FIG. 2 is used for the filtering, after filtered pixel p′[m,n] is computed using Equation [004] to [009], p′[m+3, n+3] is selected as the next pixel to be computed. Then by using Equation [004] and replacing m with m+3 and n with n+3, Equation [0010] can be used for the computation:

$${p}^{′} [ m + 3 , n + 3 ] = {\sum }_{j = n - 6}^{n + 12} {\sum }_{i = m - 6}^{m + 12} p [ i , j ] \times k [ m + 3 - i , n + 3 - j ] = ( ( p [ m + 3 , n - 6 ] + p [ m , n - 3 ] + p [ m - 3 , n ] + p [ m - 6 , n + 3 ] ) + ( p [ m + 6 , n - 3 ] + p [ m + 3 , n ] + p [ m , n + 3 ] + p [ m - 3 , n + 6 ] ) + ( p [ m + 9 , n ] + p [ m + 6 , n + 3 ] + p [ m + 3 , n + 6 ] + p [ m , n + 9 ] ) + ( p [ m + 12 , n + 3 ] + p [ m + 9 , n + 6 ] + p [ m + 6 , n + 9 ] + p [ m + 3 , n + 12 ] ) ) / 16 \qquad [ 010 ]$$

Equation [010] can be further written as:

p′[m+3,n+3]=(P1+P2+P3+P4)/16 [011]

The meanings of P1 to p3 are already defined in Equations [007] to [009], they are the same as that in Equation [005] for p′[m,n].

Meaning of P4 is shown in Equation [012]:

P4=p[m+12,n+3]+p[m+9,n+6]+p[m+6,n+9]+p[m+3,n+12] [012]

Equation [005] and [011] show that p′[m, n] and p′[m+3, n+3] share the same intermediate values P1, P2 and P3. If these intermediate values P1, P2 and P3 are calculated and stored for use for p′[m+3, n+3] when computing p′[m,n], then p′[m+3, n+3] can be computed by using Equation [012] to compute P4 first and then using Equation [011] to compute p′[m+3, n+3]. Equation [012] needs three addition operations and Equation [011] needs another three. Total of 6 additions are needed, instead of fifteen when using conventional method. The efficiency could be improved up to 60%.

Another way to reuse the intermediate values could be done this way: P0 and P are stored for using for next pixel. P is defined as:

P=P0+P1+P2+P3 [013]

Equation [014] is used to compute p′[m+3, n+3]:

p′[m+3,n+3]=(P−P4)/16 [014]

When using Equation [013] and [014], total of four addition and one subtraction operations are needed. The efficiency could be improved up to 66% compared with the conventional method.

The filter kernel for MF-1BT is used here for explaining the intermediate values sharing method provided by this invention. This is for example purpose, which should not unduly limit the scope of the claims. One of ordinary skill in the art would recognize many variations, alternatives, and modifications. The method provided here can also be used in embodiments that use other kind of filter kernels.

This invention provides a method for generating low bit-depth image G from an image F, comprising:
(1) A filter part for filtering the image F to filtered image F′. The filtered image F′ is obtained by convolution of image F and a filter kernel K. When computing the filtered pixel value for the current pixel, one or more intermediate values that can be used for the next pixel are computed and saved. When computing the filtered pixel value for the next pixel, the said next pixel is selected so that the said saved intermediate values from computing of said last pixel can be reused and these said intermediate values are reused;
(2) An output part for generating low bit-depth image G by applying comparison and other possible processing operations to F and F′.

### Third Preferred Embodiment

Another object of the present invention is to provide a method of computing the filtered image by assigning a plurality of filtered image pixels with the same value. Each time after one pixel value of filtered image is computed, one or more other pixels around this pixel are assigned with the same value without using the convolution algorithm. Because the convolution computation is not needed for pixels around the computed center pixel, the amount of computation cost is reduced.

For example, if the filter kernel for MF-1BT is used for the filtering, Equation [004] can be used to compute the filtered pixel value p′[m,n].

Then four other filtered pixels around it are assigned with the same value, as shown in Equation [013] to [016]:

p′[m+1,n]=p′[m,n] [013]

p′[m−1,n]=p′[m,n] [014]

p′[m,n+1]=p′[m,n] [015]

p′[m,n−1]=p′[m,n] [016]

Any other filter kernel can be chosen to use with the method provided by this invention. The filter kernel for MF-1BT is used here for example purpose, which should not unduly limit the scope of the claims. One of ordinary skill in the art would recognize many variations, alternatives, and modifications.

There is no limitation to how many of pixels are assigned with the same value. The number of four is selected for example purpose, which should not unduly limit the scope of the claims. One of ordinary skill in the art would recognize many variations, alternatives, and modifications.

When more pixels are assigned with the same value, more computation cost is saved, but the accuracy of the pixel value of filtered image is degraded.

### Fourth Preferred Embodiment

The fourth embodiment uses all three methods used in the first preferred embodiment, the second preferred embodiment and the third preferred embodiment.

A method for generating low bit-depth image G from an image F is provided by this invention, comprising:
(1) A image processing part for truncating one or more least significant bits (LSB) of pixels of input image F to obtain LSB-truncated image Ft;
(2) A filter part for filtering the LSB-truncated image Ft to filtered image Ft′. The filter part generates a subset of pixels of filtered image F′ by convolution of image F and a filter kernel K. Others are obtained by using this method: after one pixel value of filtered image is computed, the filtered pixel values of one or more other pixels around this said pixel are assigned with the same said computed pixel value. When carrying out the convolution of F and kernel K for a current pixel, the said filter part computes and saves one or more intermediate values that can be used for the next pixel. The said next pixel is selected so that the said intermediate values from computing of said last pixel can be reused. When computing the filtered pixel value for the said next pixel, these intermediate values are reused;
(3) An output part for generating low bit-depth image G by applying comparison and other possible processing operations to Ft and Ft′.

To further explain the method provided by this invention, an example of generating the low bit-depth image from an 8-bit 16×12 image is given below. This is for example purpose, which should not unduly limit the scope of the claims. One of ordinary skill in the art would recognize many variations, alternatives, and modifications.

FIG. 4 shows the input 8-bit depth 16×12 image F. All pixels are shown in hexadecimal values.

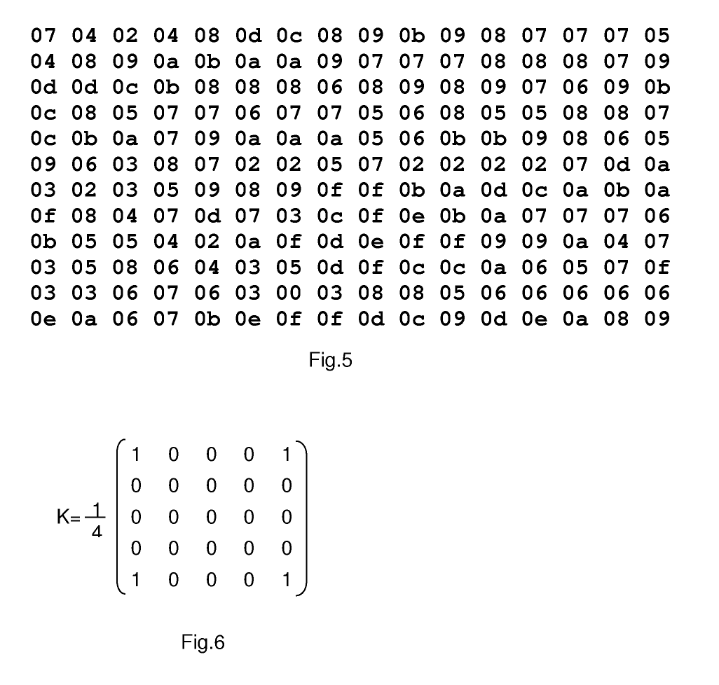

Using the method provided by this invention, the image F is converted to LSB-truncated image Ft. The number of LSBs needs to be truncated is set to be four. Each pixel in Ft is obtained by right-shifting four times the pixel value of the same position pixel in input image F. The LSB-truncated image Ft is shown in FIG. 5.

A rectangle shape filter kernel is used, as shown in FIG. 6 and Equation [017].

$$K ( i , j ) = \{ \begin{matrix}1 / 4 & if [ i , j ] = [ - 2 , - 2 ] , [ - 2 , 2 ] , [ 2 , - 2 ] or [ 2 , 2 ] \\ 0 , & otherwise\end{matrix} \qquad [ 017 ]$$

To use kernel defined by Equation [017] to obtain the filtered image Ft′ from Ft, Equation [003] can be used, which can be written as Equation [018]

$${p}^{′} [ m , n ] = {\sum }_{j = n - 2}^{n + 2} {\sum }_{i = m - 2}^{m + 2} p [ i , j ] \times k [ m - i , n - j ] = ( ( p [ m - 2 , n - 2 ] + p [ m - 2 , n + 2 ] ) + ( p [ m + 2 , n - 2 ] + p [ m + 2 , n + 2 ] ) ) / 4 \qquad [ 018 ]$$

Equation [018] can be further written as:

p′[m,n]=(P0+P1)/4 [019]

The meanings of P0 and P1 are shown in Equation [020] and [021].

P0=p[m−2,n−2]+p[m−2,n+2] [020]

P1=p[m+2,n−2]+p[m+2,n+2] [021]

Here are the steps to generate the filtered image Ft′.

Step 1: The start pixel p′[m0,n0] is selected. The first start pixel is set to be p′[1,1]. This will be the first filtered pixel to be computed.

Step 2: The 2^{nd} 3^{rd} and 4^{th} filtered pixels to be computed are selected as:

p′[m0,n0+5],p′[m0,n0+9],p′[m0,n0+13].

These pixels are selected so the method provided by this invention of reusing the intermediate values can be used.

Step 3: The selected four filtered pixels are computed using Equation [019] to [021]. In this process, the method provided by this invention of reusing the intermediate values is used. When computing 1^{st} pixel, P0 and P1 are computed first and P1 is saved for use for 2^{nd} pixel. When computing 2^{nd}, 3^{rd} and 4^{th} filtered pixels, only P1 will be computed. P0 will be reused from saved P1 of last pixel. Thus, when computing 2^{nd} to 4^{th} filtered pixels, two additions are needed instead of three when using convention method.

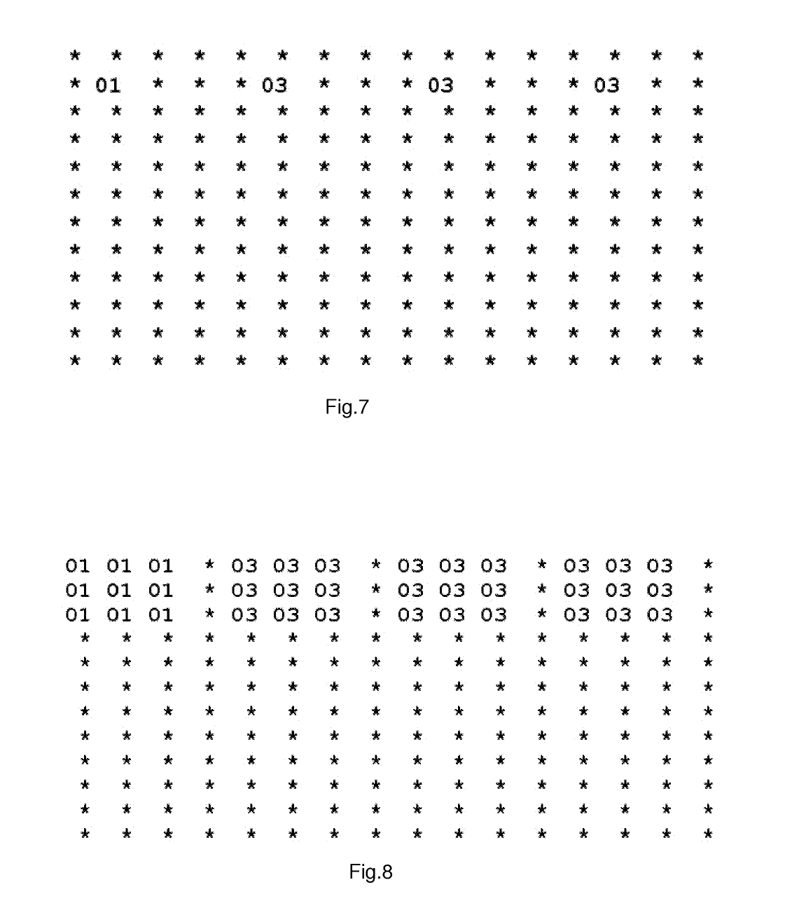

The computed 1^{st} to 4^{th} filtered pixels are shown in FIG. 7. The star symbol (*) in FIG. 6 and the following figures denotes values still not computed.

Step 4: Use the method provided by this invention to obtain the filtered pixel values around the 1^{st} to 4^{th} filtered pixels. For this example, the number of around pixels to be assigned with the same value is set to eight. So, the eight filtered pixels around the 1^{st} filtered pixel are set to the same value as that of the 1^{st} filtered pixel. The same operation is applied to pixels around 2^{nd}, 3^{rd} and 4^{th} filtered pixels. The filtered image after Step 4 is shown in FIG. 8.

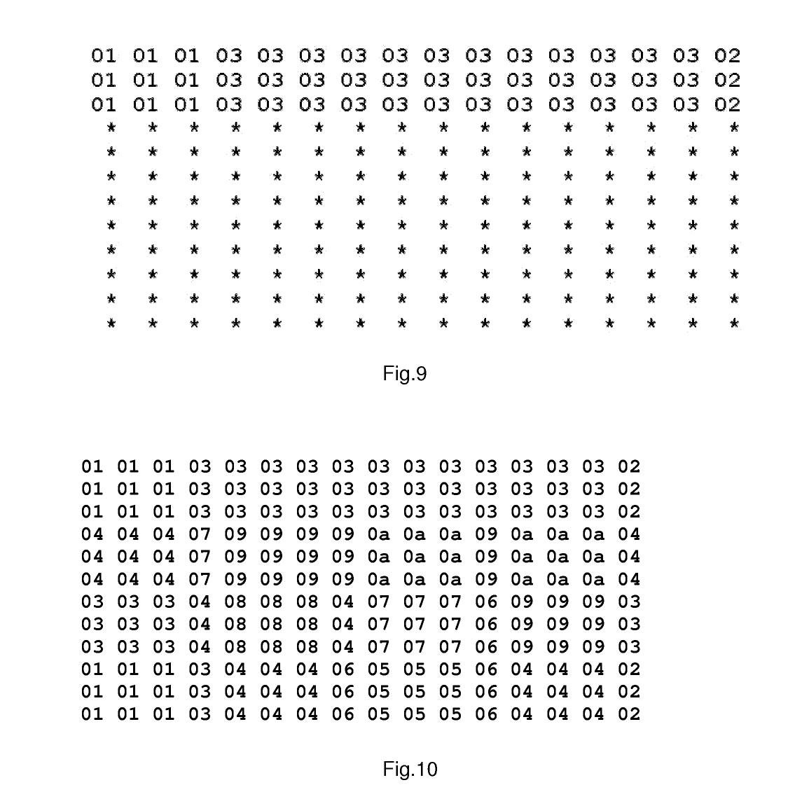

Step 5: Compute the following four filtered pixels: p′[m0,n0+3], p′[m0,n0+7], p′[m0,n0+11] and p′[m0,n0+15]. Then set the two filtered pixels atop and below each computed pixels to the same value as that of the computed pixel. The filtered image after Step 5 is shown in FIG. 9.

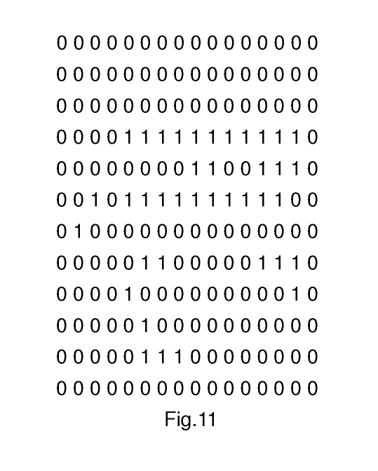

Step 6: Repeat Step 1 to Step 5 three times, each time set the Start Pixel p′[m0,n0] to the following: p′[1,4], p′[1,7] and p′[1,10]. The process of generating the filtered image Ft′ ends after all filtered image pixels are generated. FIG. 10 shows the filtered image Ft′ obtained.

The low bit-depth image can be obtained by applying comparison and other operations on LSB-truncated image Ft and filtered image Ft′. For example, an 1-BT image can be obtained by using Equation [002]. FIG. 11 shows the obtained 1-BT image.

What is claimed is:

1. A method for generating low bit-depth image G from an image F, comprising:
(1) A image processing part for truncating one or more least significant bits (LSB) of pixels of input image F to obtain LSB-truncated image Ft;
(2) A filter part for filtering the LSB-truncated image Ft to filtered image Ft′;
(3) An output part for generating low bit-depth image G by applying comparison and other possible processing operations to Ft and Ft′.

2. A method for generating low bit-depth image G from an image F, comprising:
(1) A filter part for filtering the image F to filtered image F′. The filtered image F′ is obtained by convolution of image F and a filter kernel K. When computing the filtered pixel value for the current pixel, one or more intermediate values that can be used for the next pixel are computed and saved. When computing the filtered pixel value for the next pixel, the said next pixel is selected so that the said saved intermediate values from computing of said last pixel can be reused and these said intermediate values are reused;
(2) An output part for generating low bit-depth image G by applying comparison and other possible processing operations to F and F′.

3. A method for generating low bit-depth image G from an image F, comprising:
(1) A filter part for filtering the input image F to filtered image F′. A subset of pixels of filtered image F′ is obtained by convolution computation of image F and a filter kernel K. Others are obtained by this method: after one pixel value of filtered image is computed, the filtered pixel values of one or more other pixels around this pixel are assigned with the same said computed pixel value;
(2) An output part for generating low bit-depth image G by applying comparison and other possible processing operations to F and F′.

4. A method for generating low bit-depth image G from an image F according to claim 1, wherein the said filter part generates filtered image F′ by convolution of image F and a filter kernel K. When computing the filtered pixel value for the current pixel, one or more intermediate values that can be used for the next pixel are computed and saved. When computing the filtered pixel value for the said next pixel, the said next pixel is selected so that the said intermediate values from computing of said last pixel can be reused and these said intermediate values are reused.

5. A method for generating low bit-depth image G from an image F according to claim 1, wherein the said filter part generates a subset of pixels of filtered image F′ by convolution of image F and a filter kernel K. Others are obtained by using this method: after one pixel value of filtered image is computed, the filtered pixel values of one or more other pixels around this said pixel are assigned with the same said computed pixel value.

6. A method for generating low bit-depth image G from an image F according to claim 3, wherein the said filter part computes and saves one or more intermediate values that can be used for the next pixel, when computing the filtered pixel value for the current pixel. When computing the filtered pixel value for the next pixel, the said next pixel is selected so that the said intermediate values from computing of said last pixel can be reused and these intermediate values are reused.

7. A method for generating low bit-depth image G from an image F according to claim 5, wherein the values of pixels of said subset of pixels of filtered image F′ are computed using this method: When carrying out the convolution of F and kernel K for a current pixel, the said filter part computes and saves one or more intermediate values that can be used for the next pixel. When computing the filtered pixel value for the said next pixel, the said next pixel is selected so that the said intermediate values from computing of said last pixel can be reused and these intermediate values are reused.
